(19) United States
(12) Patent Application Publication
(10) Pub. No.: US 2005/0247120 A1
(43) Pub. Date: Nov. 10, 2005

(54) Gas phase deposition of perfluorinated alkyl silanes

(76) Inventors: Patrik Hoffmann, Epalinges (CH); Gerit Kulig, Preverenges (CH); Laura Barbieri, Chavannes-pres-Renens (CH)

Correspondence Address: WALTER OTTESEN, PO BOX 4026, GAITHERSBURG, MD, 20885-4026, US

(21) Appl. No.: 11/107,886

(22) Filed: Apr. 18, 2005

Related U.S. Application Data
(63) Continuation-in-part of application No. PCT/EP03/11553, filed on Oct. 17, 2003.

(30) Foreign Application Priority Data
Oct. 18, 2002 (DE) 102 48 775.8

(51) Int. Cl. G01W 1/00

(52) U.S. Cl. 73/170.24

(57) ABSTRACT

A method for the gas phase deposition of partially fluorinated or perfluorinated alkyl silanes onto a substrate in a reaction chamber includes cleaning the substrate, hydrating the substrate with steam, drying the substrate and silanization of the substrate by deposition of the alkyl silane from the gas phase. The cleaning of the substrate is a plasma etching process and the hydration occurs directly after the plasma etching.

### CROSS REFERENCE TO RELATED APPLICATIONS

This application claims priority of international patent application PCT/EP 2003/011553, filed Oct. 17, 2003, and claiming priority from German patent application no. 102 48 775.8, filed Oct. 18, 2002, and the entire content of both applications is incorporated herein by reference.

### FIELD OF THE INVENTION

The invention relates to methods for the gas phase deposition of partially fluorinated or perfluorinated alkyl silanes on a substrate in a reaction chamber. The invention also relates to a substrate having a coating of at least partially fluorinated or perfluorinated alkyl silanes and to an optical component having a refractive or reflective substrate.

### BACKGROUND OF THE INVENTION

Every solid body is influenced by ambient conditions. In particular, chemical substances might deposit which, in case of sensitive surfaces, may constitute a disturbing contamination. The deposit may, for example, be a particle deposit (adhesion of dust particles) or a condensation of pollutants. Condensated pollutants may form droplets, which, in turn, trap dust particles. Deposits on the surfaces of optical elements are particularly disturbing since they lead to light scattering and therefore limit the function of the optical component.

A generalized approach to minimize or prevent disturbing deposits on surfaces is the deposition of functional layers which interfere with the attachment of foreign substances from the environment. Functional layers serve, in particular, to reduce the wettability or to increase the border angle or contact angle of fluids to the surface. A general description of the contact angles at interfaces of liquids and solid bodies is provided by W. A. Zisman in “Advances in Chemistry Series” (Volume 43, 1964).

The effect of functional layers is based on geometrical properties such as, for example, the calibration of a certain surface roughness (so-called “lotus-leaf effect”), or on chemical properties of the surface formed by the functional layer. The functional layers which repel contaminants known so far are generally tailored to certain problems and are optimized for certain conditions. Contaminant-repelling layers having the lotus-leaf effect can, for example, be optimized in the form of coats of paint with respect to resistance to abrasion or to weather. The layers are, however, not adequate for uses in precision optics.

In the area of optical components, the deposition of functional layers has so far not been proven successful in practice. One reason lies in particular in the fact that the number of requirements, which have to be met simultaneously, is particularly high for optical elements. In particular, functional layers have to have both high abrasion resistance as well as good optical properties. The latter comprises, for example, little scattering, high transmittance and the avoidance of color effects.

A generally known approach for the production of functional layers relies on the formation of self-assembling monolayers (or SAM-layers) from chemical compounds, which have one or more functional groups in the molecule which strongly interact with the surface to be coated. It is generally known to produce SAM-layers via deposition from the liquid phase. A general disadvantage of the liquid phase deposition of functional SAM-layers is that these layers generally have non-reproducible chemical and structural properties. For example, multilayers (three-dimensional layers) are produced which may contain foreign substances and do not release them even with after-treatments. The layers often contain solvent residues (such as water) which have particularly a negative effect on the optical properties of the functional layers. Furthermore, besides the self assembly, other reactions occur between the building blocks of the SAM-layer which influence its structure and properties (see, for example, A. Y. Fadeev et al in “Langmuir”, Volume 16, 2000, pages 7268 to 7274).

An alternative approach to the formation of SAM-layers consists of the deposition of functional chemical compounds from the gas phase (see J. Duchet et al in “Langmuir”, Volume 13, 1997, pages 2271 to 2278; P. W. Hoffmann et al in “Langmuir”, Volume 13, 1997, pages 1877 to 1880; A. Hozumi et al in “Thin Solid Films”, Volume 303, 1997, page 222 to 225; A. Hozumi et al in “Langmuir”, Volume 15, 1999, pages 7600 to 7604; O. Kakai et al in “Journal of Non-Crystalline Solids”, Volume 218, 1997, pages 280 to 285).

P. W. Hoffmann et al (1997, see above) describes the gas phase deposition of SAM-layers from perfluorized alkyl silanes on silicium oxide and germanium oxide. After cleaning the substrate in liquid fluoro acid (HF), monolayers of PFDCS (perfluorodecyldimethylchlorosilane) or PFTES (perfluorodecyltriethoxysilane) are formed in the gas phase reactor by hydration with water vapor, drying and a subsequent deposition of the actual layer. The measured characterization of the layers shows indeed the desired mutual alignment of the molecules by self assembly and a high stability of the layers. However, several disadvantages arose. For example, a complete surface coverage could not be achieved. The layers displayed a residual roughness and an increase in the inclination angles of the aliphatic molecules with an increase in coverage. The contact angles relative to water were limited to values below 115°. The quality of the formed layers was insufficient, in particular for optical use.

A. Hozumi et al describes in “Thin Solid Films,” Volume 303, 1997, pages 222 to 225, the production of hydrophobic layers from TMS (tetramethylsilane) and FAS (fluoroalkylsilane) on Si— or glass substrates by plasma-assisted CVD in an evacuated reactor. These layers have higher contact angles relative to water and thereby a reduced tendency towards wetting. However, the plasma-assisted CVD did also not produce a sufficient quality of the layer, in particular, for optical applications. The deposited layers are not self-assembling monolayers but feature a high roughness of more than 10 nm thus negatively affecting the light scattering at the surface. Particles can form at the surface as a result of the plasma process. Those particles reduce the quality of the layer and in particular the abrasion resistance.

The formation of FAS monolayers on silicon substrates with an oxidated hydroxilinated surface is described by A. Hozumi et al in “Langmuir”, Volume 15, 1999, pages 7600 to 7604. A positioning of the substrate in a closed vessel together with a liquid FAS specimen takes place after the following: a photochemical cleaning of the surface with UV light for removing organic contamination, the formation of an oxide layer and a hydration at room temperature. In the vessel, a vaporization of the liquid occurs and a reaction of FAS with the OH groups on the surface. This method is disadvantageous because of the difficult substrate manipulation and the limited controllability of the layer formation. The contact angles of the monolayers relative to water reach a maximum of 112°. With such a contact angle, only an inadequate adhesion producing action of the monolayers can be achieved especially for optical applications.

### SUMMARY OF THE INVENTION

It is an object of the invention to provide improved methods for gas phase deposition of partially fluorinated or perfluorinated alkyl silanes with which the disadvantages of conventional deposition methods can be overcome and, resulting from these methods, layers having an improved quality, especially for optical applications, are formed. A layer produced in accordance with the invention should be distinguished especially by improved optical characteristics (reduced scattering, increased transmission, colorlessness), improved mechanical characteristics (increased resistance to abrasion, continuity and no holes), improved homogeneity (constant thickness, less roughness), increased density in the monolayer, reproducible chemical characteristics, an increase of the surface tension and/or an increase of the contact angle. It is a further object of the invention to provide an improved substrate layer composite which is formed on the substrate by gas phase deposition of partially fluorinated or perfluorinated alkyl silanes.

These objects are solved with methods and coated substrates having the features of patent claims 1, 11, 12, 13, 14, 15 or 19. Advantageous embodiments and applications of the invention result from the dependent claims.

The basic idea of the invention is to further develop a method for gas phase deposition of partially fluorinated or perfluorinated alkyl silanes on a substrate so that the substrate is subjected to a cleaning by plasma etching in advance of hydration and the hydration takes place directly after the plasma etching. The plasma cleaning in combination with the directly-following hydration affords the advantage that a clean and contamination-free, especially hydrocarbon-free substrate surface is made available in advance of layer deposition with the substrate surface being occupied homogeneously with hydroxy groups (OH groups). In this way, the conditions for the self-assembling formation of monolayers is improved. This becomes manifest in considerably improved parameters of the layer quality which is explained in detail hereinafter. The risk of further contamination, as can occur in conventional wet cleaning, is completely avoided.

According to a preferred embodiment of the invention, the gas phase deposition takes place in an evacuated reactor without intermediate aeration between the individual method steps. In this way, a deposit of contaminants after the plasma etching can be advantageously avoided and the purity and homogeneity of the prepared substrate can be maintained up to the layer deposition. According to the invention, layers are deposited free of water.

The plasma etching preferably includes an oxygen plasma etching at a pressure in the range of 60 Pa to 200 Pa. With this measure, coatings having an especially high quality are obtained with the method of the invention. The oxygen plasma etching is preferred because it makes possible that easily volatile organic contaminations are oxidized which possibly could deposit from the ambient atmosphere onto the substrate.

According to a further preferred embodiment of the invention, the drying and/or the gas phase deposition (silanization) can take place at an increased substrate temperature preferably in the range of 100° C. to 150° C. Under these conditions, the layer quality can be further improved.

Further advantages can result when, after the gas phase deposition, an evacuation of the reactor for removing silane residues, binaries and/or oligomers and/or a wet cleaning of the coated substrate take place. In this way, the molecular packing in the layer composite and the mechanical durability of the layers can be improved.

According to the invention, at least a partially fluorinated or perfluorinated alkyl silane is deposited onto the clean substrate surface. The alkyl silane has the general formula R_{y}—Si-Lₓ wherein R is the functional group to determine the surface characteristics of the layer (surface group) and L is the functional group for bonding to the substrate (bonding group) having 0<y<4, 0<x<4 and x+y=4.

The bonding group L determines the bonding capability of the molecules to the cleaned activated surface. Generally, all functional groups are suitable as bonding groups which, with the OH groups on the substrate surface lead to a chemical reaction (especially a condensation reaction to covalent Si—O-substrate bonds (for example, Si—O—Si for layer deposition on silicon oxide)). Examples of bonding groups are:
Halogens, for example, —Cl, —Br, -J.
Amines A₂N—, wherein A=H, Me, Et, Prop, But, or mixed groups such as H—N-Prop, or
Alkoxides, for example, —OMe, —OEt, OProp, et cetera.

The function of the surface group R determines the surface characteristics of the coated substrate. Especially inert and water repellent (hydrophobic) and possibly oil repellent (oleophobic) groups are used whose number matches the number of the bonding groups so that the bonding locations of the silicon are saturated.

For y>1, the surface groups can be identical or different. The surface group R includes preferably hydrophobic alkyl chains which are partially fluorinated or perfluorinated.

The chain length of the alkyl chain is selected according to Si—(CH₂)ₙCH₃ with 0≦n<30. Also, molecules with longer alkyl chains can be used depending upon application. In the event that only a bonding group L is provided (x=1), the maximum chain length of the three surface groups R each reduces to a maximum of 18. Under these conditions, the vapor pressure of the alkyl silanes is adequately large in order to realize an effective gas phase deposition. Alternatively, the chains can branch or can have different lengths. For example, a C18 chain and two CH₃ groups (n=0) can be present on a silicon atom.

Alternatively, disilanes or other silanes, which react with OH groups via condensation reactions, can be used. Such a silane is, for example, the hexamethyldisilane Me₃Si—NH—SiMe₃ (CAS Nr.: [999-97-3]). Alternatively, silanoles can be used which comprise the above-described silanes and a functional OH group.

Additional embodiments of the invention are provided by substrates which carry a coating of partially fluorinated or perfluorinated alkyl silanes at least on a part of their surfaces. These partially fluorinated or perfluorinated alkyl silanes are produced by gas phase deposition. The coated substrate or the composite of substrate and coating are distinguished by a series of improved optical, mechanical and chemical characteristics which are formed individually or in combination. The coated substrates are produced as a monolayer in accordance with the method of the invention.

The substrate of the invention is distinguished in that the alkyl silane coating has a transmission of at least 95%, especially 99%. Correspondingly, the composite of substrate and coating has a transmission of at least 95%, especially 99% of the transmission of the substrate or a reflectivity of at least 95%, especially 99% of the reflectivity of the substrate. For the first time, alkyl silane monolayers can be prepared for optical precision applications.

A substrate according to the invention is characterized in that the coating has a roughness of less than 0.5 nm, especially less than 0.3 nm. The roughness (RMS) characterizes the standard deviation of the measuring points (elevation) from the mean elevation. The low roughness is especially advantageous for the optical characteristics of the coating.

A substrate of the invention is characterized in that the coating has a surface energy of at most γ=15 mN/m, especially at most γ=13 mN/m. The coating is therefore superior to conventionally often used PTFE with respect to the anti-adhesion characteristics.

A substrate of the invention is characterized in that the coating has a contact angle greater than 120° with respect to water. This considerably improves the dirt repelling action.

A substrate of the invention is characterized in that the coating has an F atom concentration of at least 30% on its surface with this F atom concentration being determined by XPS measurements.

According to a preferred embodiment of the invention, the substrate comprises a solid state body which comprises, at least at its surface, silicon oxide, especially SiO₂. The substrate can be made, for example, of SiO₂ (for example, glass, quartz glass) or a ceramic which has an SiO or SiO₂ layer (or a stoichiometrically mixed layer) on its surface. The substrate can also be of silicon which is oxidized on its surface.

It is especially advantageous when the substrate is used as an optical component which is generally a transparent, light refractive or light reflecting solid body such as an optical lens, a prism or other beam deflecting component. The alkyl silane coating can be formed without limiting the function of the optical component. The optical characteristics of the component are almost completely retained (better than 99%). Preferably, the optical component has a smooth and continuous surface form.

Advantageously, the alkyl silane layer formed in accordance with the invention as a closed monolayer having a thickness less than 2 nm of the surface structure follows the surface structure. In this way, the invention is applicable also for the homogeneous, closed coating of substrates having a microstructure. The silanization is a chemical surface reaction, which takes place on all sides of structures of the substrate surface, and the coating deposition takes place free of shadows. For example, an optical component, which is provided with a reflection reducing microstructure, can be additionally covered with a monolayer of partially fluorinated or perfluorinated alkyl silane so that the reflection reduction is combined with a dirt repelling action.

### BRIEF DESCRIPTION OF THE DRAWINGS

The invention will now be described with reference to the drawings wherein:

FIG. 1 is a schematic of a through-flow reactor for carrying out the method of the invention;

FIG. 2 is a flowchart for showing an embodiment of the method of the invention;

FIG. 3 shows the structural formulas of the deposited alkyl silanes;

FIG. 4 is a schematic showing the formation of layers in accordance with the invention; and,

FIGS. 5 to 7 show measuring results obtained with substrates coated in accordance with the invention.

### DESCRIPTION OF THE PREFERRED EMBODIMENTS OF THE INVENTION

In the following, the invention will be explained by way of example with reference to the gas phase deposition in a through-flow reactor. The realization of the invention is, however, not perforce tied to the use of the through-flow reactor. Alternatively, other evacuable, closed reactors having units for realizing the method steps explained hereinafter can be used, preferably without intermediate aeration. The through-flow reactor has advantages with reference to the precise adjustment of reaction parameters and a coating at high batch production. With extensive investigations, the inventors have determined that the layer quality is sensitively dependent upon the interaction of different reaction parameters. The examples explained below are used preferably for coating optical components to have a high water repellence and to have reproducible coating characteristics.

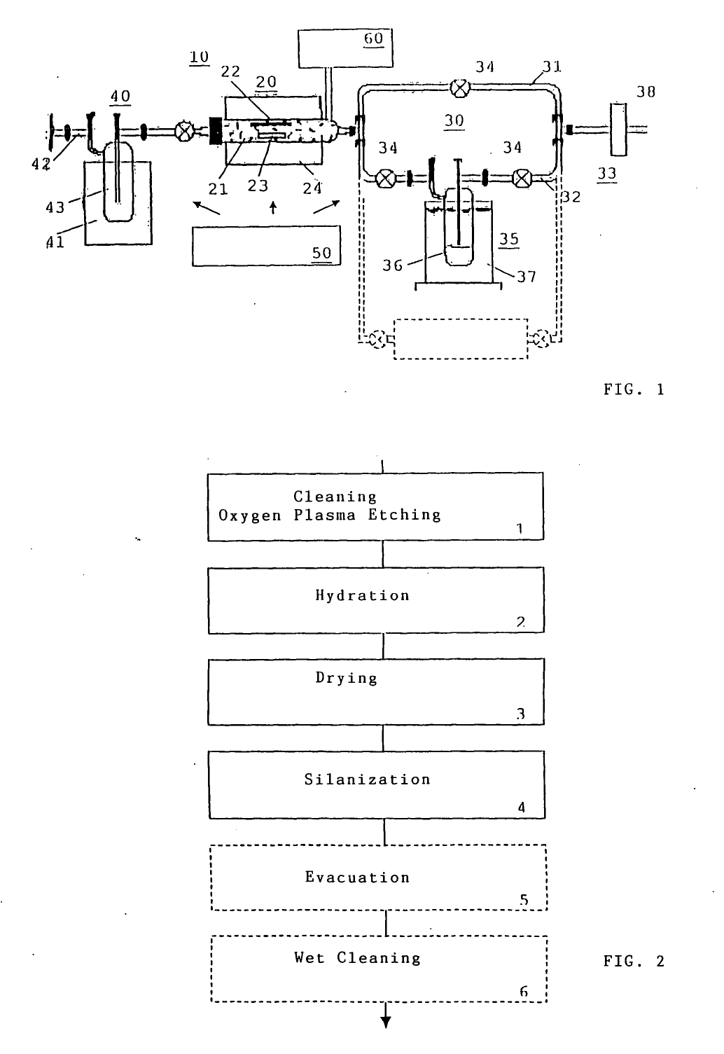

The through-flow reactor 10 of FIG. 1 includes a deposition unit 20, a supply unit 30 connected to the input end of the deposition unit and an output unit 40 connected to the output end of the deposition unit. The deposition unit 20 includes a reaction chamber 21 having a plasma device 22 and a substrate holder 23. The plasma device 22 is, by way of example, of the type “Plasmaline 415”, Barrel Type Asher, Tegal Corp. The reaction chamber 21 is mounted in a heater unit 24 with which the temperature of the reaction chamber 21 can be adjusted in a range up to 200° C. The reaction chamber 21 is, for example, a quartz tube having a length of 40 cm and a diameter of 2 cm. For example, substrates having dimensions up to 1.5×0.5×10 cm³ can be coated. For larger substrate surfaces, the size of the reactor 10 can be easily adapted.

The heating unit 24 is preferably an oven having a resistance heater. The reaction chamber 21 can be evacuated by a pump unit 60 up to a pressure of 10 Pa. The pump unit 60 includes, for example, a two-stage piston pump.

The supply unit 30 includes a branched conduit system which is provided for introducing inert gas or reaction gas into the reaction chamber 21. Especially a first branch 31 for supplying inert gas is provided and a second branch 32 is provided for supplying reaction gas. Both branches (31, 32) are connected upstream to a controllable inert gas source 33. The reference numerals (34a, 34b, 3 4c) identify actuators such as valves in the lines of the supply unit 30.

The first branch 31 extends from the inert gas source 33 via a first actuator 34a directly to the reaction chamber 21. The second branch includes a reaction gas source 35 (a so-called bubbler) having a vessel 36 which contains the coating substance (alkyl silane) or another vapor source (for example, water) and can be controlled with respect to temperature by a water bath 37. The second branch extends from the inert gas source 33 likewise to the reaction chamber 21 via a second actuator 34b, the reaction gas source 35 and a third actuator 34c. In FIG. 1, an additional branch is shown in phantom outline parallel to the second branch 32. The additional branch is provided to simultaneously make available the vapor source 35 of the coating substance and a water vapor source (shown schematically).

The lines in the branches (31, 32) are quartz pipes which are maintained at a temperature of approximately 10 to 15° C. above the temperature of the water bath 37 in order to avoid a silane condensation on the inner walls. By actuating the actuators (34a, 34b, 3 4c), there is a control as to whether a pure inert gas flow or a mixture flow of inert gas and reaction gas flows into the reaction chamber. The gas flows can be adjusted by an inert gas control 38. Nitrogen or argon is used, for example, as an inert gas.

The discharge unit 40 includes a cooling trap 41 to trap reaction products or reaction gas, which is not precipitated, and an output line 42 which is connected to a disposal system. The cooling trap 41 is, for example, a Dewar vessel which is filled with liquid nitrogen. A collector vessel 43 is mounted in the Dewar vessel.

The through-flow reactor 10 is furthermore equipped with a control unit 50 with which the above-mentioned system components are controlled, especially the mass flow control 38, the actuators (34a, 34b, 3 4c), the substrate temperature and the plasma unit 22.

Carrying out the method of the invention is explained in the following with reference to the steps shown in FIG. 2. Preparation steps such as placing the substrate in the reaction chamber 21 or the start-up operation of the reactor 10 and possible rework steps are known to those skilled in the art so that these will not be explained in detail here. After the substrate is positioned on the substrate holder 23, first a cleaning of the substrate via plasma etching takes place in step 1. Preferably, an oxygen plasma etching at a pressure of 60 Pa to 180 Pa (preferably, 100 Pa to 130 Pa (0.8 to 1 Torr)) at a power of 75 W is carried out for 10 minutes. Alternatively, a water plasma etching can be provided for which the supply unit 30 would have to be correspondingly adapted.

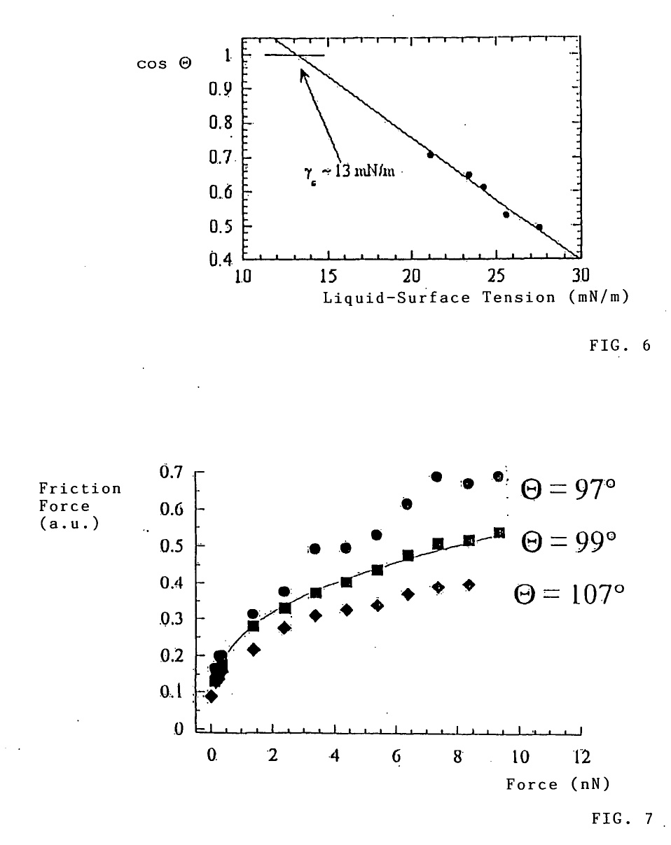

The hydration 2 follows directly after the cleaning 1. For hydration, the cleaned substrate is subjected to water vapor from a deionized water bath at 80° C. The water bath is connected to the supply unit 30 via a further branch or, in lieu of the reaction gas source 35, is connected to the reactor 10. The hydration 2 preferably takes place for a duration of 10 s. The combination of cleaning 1 and the directly-following hydration 2 affords an advantageous action for adjusting a contact angle (see FIG. 5).

The following step 3 includes drying of the substrate, which is activated with OH groups, for removal of excess water possibly absorbed on the surface. The drying takes place by heating up the substrate in a vacuum or in a through-flow of dry, inert gas (for example, nitrogen) at several hundred degrees C., for example, 400° C. The substrate can be partially deactivated by the drying 3 at temperatures which are too high. For this reason, a temperature range of between 100° C. to 150° C. and a drying duration of 1 to 15 minutes is set. Especially good deposition results were obtained by drying at 150° C. with a drying duration of 2 minutes.

The silanization 4 includes the gas phase deposition of the alkyl silane on the activated dried substrate. Already during the drying 3, the reaction gas source 37 is activated and the third actuator 34c is initially closed. The alkyl silane in the vessel 36 is warmed in the water bath 37. The temperature is adjusted in accordance with the vapor pressure of the alkyl silane and the desired through-flow speed through the reaction chamber 21. For example, a temperature of the water bath 37 is adjusted in the range of 80° C. to 120° C., preferably 90° C. Directly after drying 3, the third actuator 34 is opened and the alkyl silane vapor passes into the reaction chamber 21. During the silanization 4, the temperature of the substrate is preferably in the range of 100° C. to 150° C. The silanization duration lies in the range of, for example, 20 minutes up to more than an hour depending upon the coating material.

After the silanization 4, the deposition operation according to the invention itself is completed. According to modified embodiments, an evacuation step 5 and/or an external wet cleaning 6 can take place which is shown in phantom outline in FIG. 2. The first step defines a rest phase wherein the reaction chamber 21 is evacuated for a rest time of, for example, 20 minutes by the pump unit 60 or is flowed through with inert gas. Possibly present binary or small oligomers can be removed from the substrate which could have arisen during the silanization reaction. Step 5 takes place at a substrate temperature of, for example, 150° C.

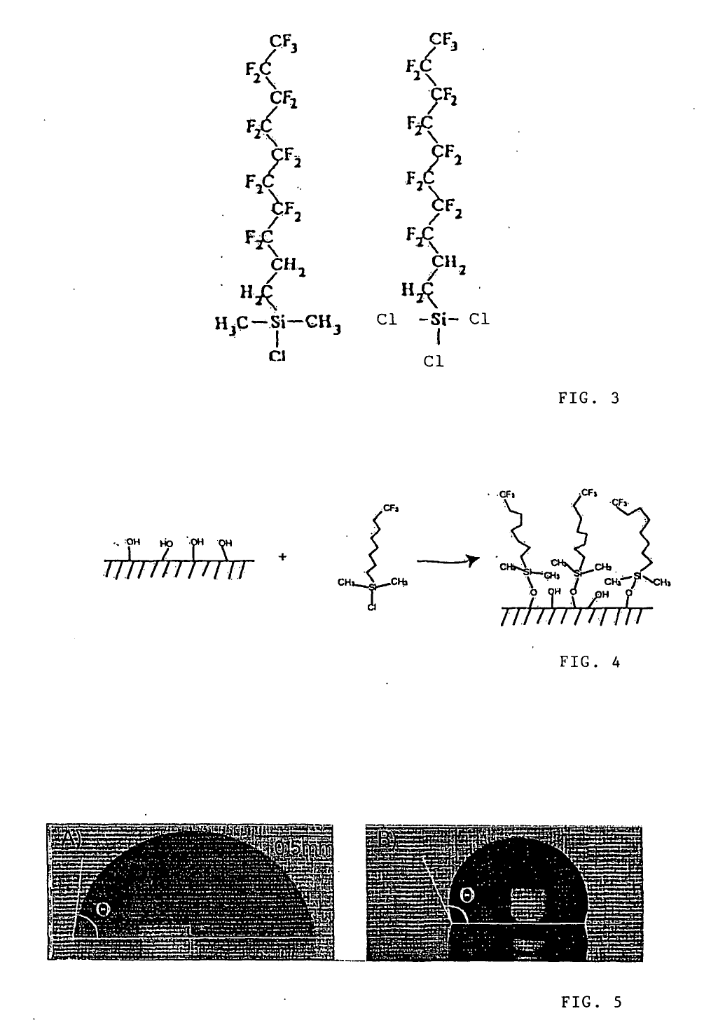

In FIG. 3, structure formulas are shown by way of example for the alkyl silane used in accordance with the invention. The characteristics of these molecules are, for example, described in the above-mentioned publication of P. Hoffmann et al. A further, preferred alkyl silane is the trifunctionalized PF3 (CF₃—(CF₂)₇—(CH₂)₂—Si—Cl₃, CAS-Nr.: [785 60-44-8], produced by ABCR GmbH & Co. KG of Germany.

The bonding of a molecule according to FIG. 3 (left) is symbolically illustrated in FIG. 4. The hydroxilized substrate carries a multiplicity of OH groups on its surface. The Cl bond to the Si is replaced by the bond of the Si to the O atoms of the OH groups because of the interaction with the vapor of the alkyl silane molecules. The HCl formed in this manner is conducted out of the reactor chamber 21 with the inert gas flow. The bonding of a plurality of alkyl silane molecules is illustrated in the right hand portion of FIG. 4. The chains of these alkyl silane molecules project essentially perpendicularly from the substrate surface and are tightly packed and form a brush-like coating. The monolayer is formed by a single layer of the alkyl silane molecules at a thickness which corresponds essentially to the chain length of the molecules. The ends of the molecule chains form a new hydrophobic surface.

### Embodiments

Coatings produced in accordance with the invention with the molecules PF3 (see above) are characterized by the following methods and measurement parameters.

### Optical Characteristics

Transmission measurements on a coated quartz glass (coating with PF3, thickness <2 nm) resulted in a transmission of the coating of over 99%. A high transmission of this kind could not be obtained with conventional layers of alkyl silanes.

### Measurement of the Contact Angle and Determination of the Critical Surface Energy

For determining the contact angle of water on the surface coated in accordance with the invention, equilibrium measurements (monitoring contact angles at deposited drops) and dynamic measurements (monitoring the hysteresis performance) were carried out.

FIG. 5 shows the formation of the contact angle of water on a PF3 coated surface. The view A shows a conventional alkyl silane coating with a contact angle of 90°. In this coating, the combination of the invention of cleaning via plasma etching and hydration was not realized. In the method of the invention, the view B results with a considerably increased contact angle. The view B shows a contact angle of 107°. For further coatings, still higher contact angles up to 123° were obtained and this at especially a silane temperature of 80° C., a deposition duration of 25 minutes and a substrate temperature of 150° C.

The contact angle of 123° relative to water obtained with the invention defines a significant advantage compared to conventional hydrophobic coatings. Advantageously, it has been shown that the high contact angle is maintained also in long-term tests under ambient conditions in the free atmosphere (weathering or exposure).

Measurements of the contact angle relative to organic liquids and a so-called Zisman illustration of the measurement results according to FIG. 6 yielded a value of 13 mN/m as a critical surface energy. This surface energy demonstrates the superiority of the coating of the invention. For example, PTFE with 18 mN/m has a surface energy greater by a factor of approximately 1.5.

The hysteresis angle between leading and trailing contact angles is 27°. This value likewise defines an improvement compared to conventionally measured hysteresis data.

### AFM Measurements

Coating results were investigated with a commercially available AFM system (type: autoprobe M5, Park Scientific Instruments System). A standard Si₃N₄ tip with k=0.06 N/m was used. The AFM topographical images yield a considerably improved homogeneity of the specimens silanisized with PF3 in accordance with the invention. Roughness values of less than 0.3 nm were obtained.

FIG. 7 illustrates the results of AFM friction measurements which confirm the contact angle results described above. In FIG. 7, the friction force (arbitrary units) is plotted as a function of the contact force (nN) of an AFM tip for three different specimens. The AFM tip moves at 20 μm/s over the specimen. It is shown that an increase of the contact angle (reduced wettability) is correlated with a reduction of friction force. For the specimen having the contact angle 107°, the friction force is virtually independent of the contact force. It has been further shown that a considerable reduction of the friction force to approximately 50% is obtained with an increase of the contact angle. This shows that even slight contact angle increases have considerable effects in practice for the non-wettability. In addition, the resistance to abrasion of the coating increases.

### XPS Measurements

X-ray photoelectronic spectrographic measurements (XPS measurements) make possible a characterization of the packing density of the alkyl silane molecules in the layer formed in accordance with the invention. The hydrophobic action of the layer correlates with the packing density. XPS measurements were carried out with an Axis Ultra Kratos XPS system having monochromatic Al K_{α} radiation (1486.6 eV). The results of the XPS measurements are shown in the following table.

| | | |
|---|---|---|
| % At.Conc. | % At.Conc. | % At.Conc. |
| for θ = 123° | for θ = 117° | for θ = 96° |

| Signal | 0° | 70° | 0° | 70° | 0° | 70° |
|---|---|---|---|---|---|---|
| F 1s | 27.97 | 30.98 | 24.55 | 29.28 | 17.73 | 21.30 |
| C 1s | 13.93 | 30.04 | 17.68 | 31.28 | 14.03 | 28.38 |
| Si 2p | 39.77 | 21.16 | 39.03 | 21.42 | 47.13 | 26.81 |
| O 1s | 19.33 | 17.82 | 18.74 | 18.03 | 21.12 | 23.52 |

The table shows the XPS analysis results for three specimens having different contact angles each for two measurement angles (0°, 70°) and different atom concentrations (F, C, Si and O). The measuring results show an increase of the F concentration in correspondence to the increase of the contact angle. The number of CF₃ groups on the coating surface is considerably increased compared to conventional layers. The table also shows that the detectable Si concentration and O concentration reduce with an increasing contact angle of the specimens. This result, in turn, confirms the increasing packing density of layers according to the invention.

### Weathering or Exposure Tests

The resistance to weather of PF3 layers was tested in that coated specimens were stored several weeks in free air. The air temperature and humidity were recorded. Furthermore, a storage of two weeks in a climate chamber at defined temperature and moisture took place. The storage took place in correspondence to the conditions which are fixed in the standard DIN QUV. Finally, a one month simulation of weather conditions (for example, wind, UV radiation, rain and temperature changes) took place. In all cases, a reduction of the contact angle by maximally 10° resulted. This means that the layer quality is essentially maintained.

### Applications

The method of the invention can be applied in all cases wherein already conventional dirt-repelling coatings are generated by self-organizing monolayers.

A preferred and first-time application of alkyl silane coatings is provided in accordance with the invention for the coating of light-transmissive, transparent or reflective substrates such as optical components or other light-transmissive components. As optical components, for examples, lenses, mirrors or other optical surfaces are coated. Complex mirror components such as DMD components (digital mirror device components) or spectacle lenses can also be coated.

The optical components can also exhibit a subwavelength microstructure. Advantageously, the coating of the invention follows this structure so that, for example, anti-reflection characteristics are maintained even with an application of the alkyl silane coating in accordance with the invention.

The method of the invention can be further applied in cases wherein dirt-repelling coatings are generated with other techniques. Especially because of the high resistance to abrasion, window components and especially windshields can be coated.

1-21. (canceled)

22. A method for the gas phase deposition of partially fluorized or perfluorized alkyl silane on a substrate in a reaction chamber, the method comprising the steps of:
cleaning the substrate via plasma etching;
immediately after said cleaning, hydrating the substrate with water vapor;
drying the substrate; and,
silanizing said substrate by depositing said alkyl silane from the gas phase.

23. The method of claim 22, wherein all steps are performed in the reaction chamber without intermediate aeration.

24. The method of claim 22, wherein the plasma etching comprises an oxygen plasma etching at a pressure in the range of 60 Pa to 180 Pa.

25. The method of claim 22, wherein the hydration takes place with vapor from a water bath comprising demineralized, bidestilled water.

26. The method claim 22, wherein the temperature of the substrate is adjusted to within a range of 100° C. to 150° C. for said drying with said drying having a duration in a range of from 1 min up to 15 mins.

27. The method of claim 22, wherein the temperature of the substrate is adjusted within a range of 100° C. to 150° C. for said silanizing having a silanization duration in a range from 20 mins up to 60 mins.

28. The method of claim 22, wherein, after said silanization, an evacuation of the reactor is carried out for the removal of silane residues, binaries and/or oligomers.

29. The method of claim 22, wherein, after the silanization or the evacuation, a treatment with inert gas of the coated substrate is carried out.

30. The method of claim 22, wherein one or more compounds selected from the following group are used as perfluorized alkyl silane:
(a) silanes having the general formula Ry-Si-Lx, wherein R is a functional surface group for the determination of the surface properties of the deposited alkyl silane, and L is a functional binding group for attaching the alkyl silane to the substrate with 0<y<4, 0<x<4 and x+y=4,
(b) disilanes which are formed from silanes according to (a), and
(c) silanols which are formed from silanes according to (a) and which have a functional OH group.

31. The method of claim 30, wherein the binding group L is selected from one or more of the groups which comprise halogens, amines, alkoxides, and the surface group R is a hydrophobe alkyl chain, which is partially fluorized or perfluorized.

32. A substrate comprising a coating of at least one partially fluorized or perfluorized alkyl silane, wherein the coating has a transmittance of at least 95% or a reflectivity of at least 95%.

33. The substrate of claim 32, wherein the coating is a monolayer.

34. The substrate of claim 32, wherein the substrate is an optical component.

35. The substrate of claim 32, wherein the substrate is a window component for construction.

36. A substrate comprising a coating made of at least one partially fluorized or perfluorized alkyl silane, wherein the coating has a roughness of less than 0.5 nm.

37. The substrate of claim 36, wherein the coating is a monolayer.

38. The substrate of claim 36, wherein the substrate is an optical component.

39. The substrate of claim 36, wherein the substrate is a window component for construction.

40. A substrate comprising a coating made of at least one partially fluorized or perfluorized alkyl silane, wherein the coating has a surface energy of up to γ=15 mN/m.

41. The substrate of claim 40, wherein the coating is a monolayer.

42. The substrate of claim 40, wherein the substrate is an optical component.

43. The substrate of claim 40, wherein the substrate is a window component for construction.

44. A substrate comprising a coating made of at least one partially fluorized or perfluorized alkyl silane, wherein the coating has relative to water a contact angle above 120° C.

45. The substrate of claim 44, wherein the coating is a monolayer.

46. The substrate of claim 44, wherein the substrate is an optical component.

47. The substrate of claim 44, wherein the substrate is a window component for construction.

48. A substrate comprising a coating made of at least one partially fluorized or perfluorized alkyl silane, wherein the coating has, at its surface an F-atom concentration of at least 30% as determined by XPS-measurement.

49. The substrate of claim 48, wherein the coating is a monolayer.

50. The substrate of claim 48, wherein the substrate is an optical component.

51. The substrate of claim 48, wherein the substrate is a window component for construction.

52. An optical component comprising a refractory or reflective substrate on which a coating is formed of partially fluorized or perfluorized alkyl silane.

53. The optical component of claim 52, wherein said optical component has a flat or curved surface.

54. The optical component of claim 53, wherein said optical component has a surface having reflection reducing microstructures which are covered by the coating.
